(19) United States
(12) Patent Application Publication
(10) Pub. No.: US 2009/0210944 A1
(43) Pub. Date: Aug. 20, 2009

(54) Anti-maleware data center aggregate

(75) Inventor: Asaf Greiner, Ramot Jerusalem (IL)

Correspondence Address: ABELMAN, FRAYNE & SCHWAB, 666 THIRD AVENUE, 10TH FLOOR, NEW YORK, NY, 10017, US

(73) Assignee: COMMTOUCH SOFTWARE LTD.

(21) Appl. No.: 12/322,546

(22) Filed: Feb. 3, 2009

Related U.S. Application Data
(60) Provisional application No. 61/028,618, filed on Feb. 14, 2008.

(51) Int. Cl. G06F 21/00; G06F 11/30

(52) U.S. Cl. 726/24; 726/22

(57) ABSTRACT

A method for reducing object scanning load in a network, the method including employing a data-center to provide to a client identifying information and classification information relating to a plurality of objects, at the client, obtaining identifying information for a given object, at the client, comparing the identifying information for the given object to the identifying information relating to the plurality of objects and if identifying information relating to one of the plurality of objects is the same as the identifying information for the given object, relying on the classification information relating to the one of the plurality of objects as provided by the data-center.

### REFERENCE TO RELATED APPLICATIONS

Reference is made to U.S. Provisional Patent Application Ser. No. 61/028,618, filed Feb. 14, 2008 and entitled ANTI-MALEWARE DATA CENTER AGGREGATE, the disclosure of which is hereby incorporated by reference and priority of which is hereby claimed pursuant to 37 CFR 1.78(a) (4) and (5)(i).

### FIELD OF THE INVENTION

The present invention relates to systems and methods for object security scanning.

### BACKGROUND OF THE INVENTION

The following published patent documents are believed to represent the current state of the art: U.S. Pat. Nos. 6,021,510; 6,094,731; 2006/0174344 and 2006/0224724.

### SUMMARY OF THE INVENTION

The present invention seeks to provide improved systems and methods for object security scanning. Specifically, the present invention seeks to provide systems and methods for reducing the security scanning load of an antivirus system in a network such as the Internet.

There is thus provided in accordance with a preferred embodiment of the present invention a method for reducing object scanning load in a network, the method including employing a data-center to provide to a client identifying information and classification information relating to a plurality of objects, at the client, obtaining identifying information for a given object, at the client, comparing the identifying information for the given object to the identifying information relating to the plurality of objects and if identifying information relating to one of the plurality of objects is the same as the identifying information for the given object, relying on the classification information relating to the one of the plurality of objects as provided by the data-center.

Preferably, the method also includes, prior to the employing a data-center to provide, employing the data center to select the plurality of objects. Additionally, the employing the data-center to select includes employing the data-center to select popular objects as the plurality of objects. Alternatively, the employing the data-center to select includes employing the data-center to select objects for which classification information was last obtained a predetermined time duration earlier as the plurality of objects.

In accordance with a preferred embodiment of the present invention the method also includes, prior to the employing a data-center to provide, obtaining the identifying information and the classification information for each of the plurality of objects. Additionally, the obtaining is carried out at the data-center. Alternatively, the obtaining is carried out by a plurality of clients, and the plurality of clients provide the identifying information and the classification information to the data-center.

Preferably, the object includes a web based resource, and the object identifying information includes a URI.

In accordance with a preferred embodiment of the present invention the object includes a web based resource and the object identifying information includes at least one of a result of a function carried out on a URI of the web based resource and a result of a function carried out on the web based resource.

Preferably, the classification information includes an anti-virus classification of the object.

In accordance with a preferred embodiment of the present invention the method also includes, following the comparing, if identifying information for the given object is not the same as identifying information relating to any of the plurality of objects, calculating the classification information for the given object at client and providing the identifying information for the given object as obtained at client to the data-center. Additionally, the method also includes, following the providing the identifying information, providing the classification information for the given object as calculated at client to the data-center.

### BRIEF DESCRIPTION OF THE DRAWINGS

The present invention will be understood and appreciated more fully from the following detailed description, taken in conjunction with the drawings in which:

FIGS. 1A and 1B together are a simplified flowchart illustrating functionality for reducing anti-virus scanning load by employing an anti-virus resource data-center.

### DETAILED DESCRIPTION OF PREFERRED EMBODIMENTS

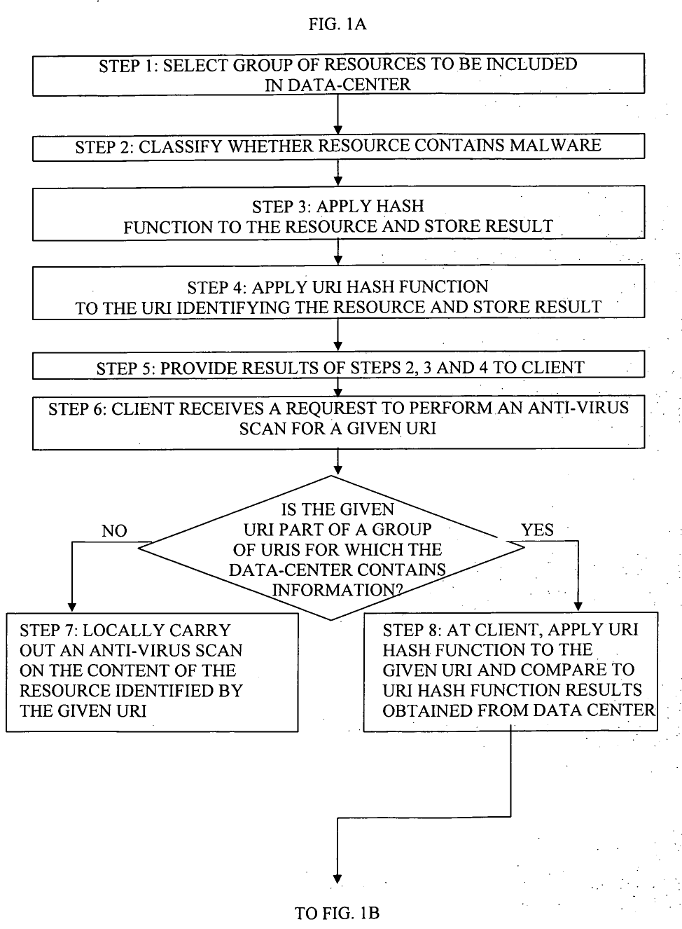

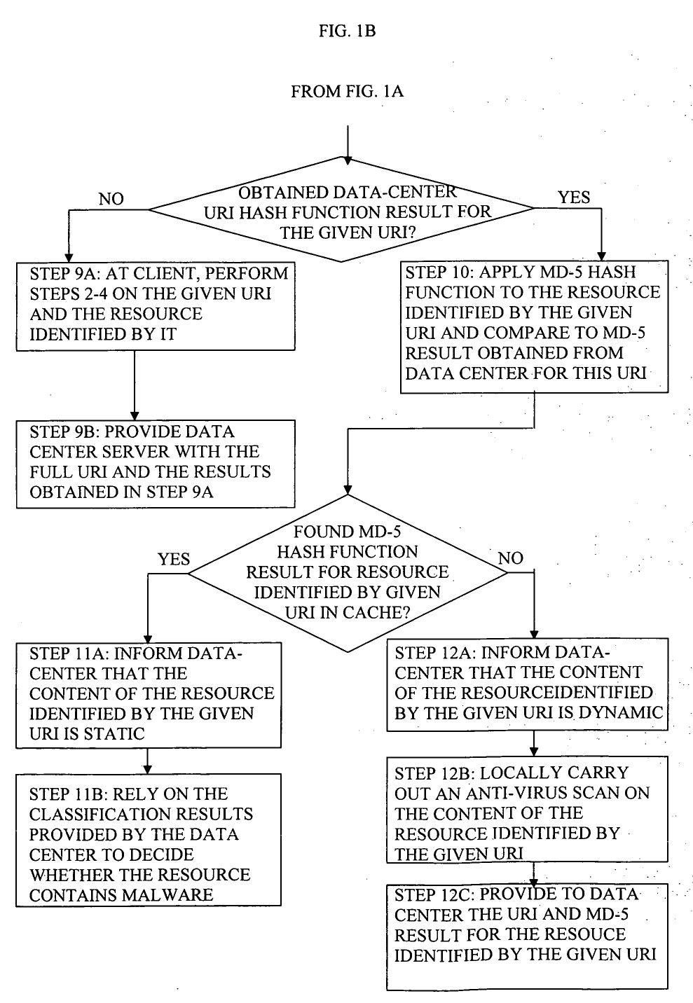

Reference is now made to FIGS. 1A and 1B, which together are a simplified flowchart illustrating functionality for reducing anti-virus scanning load by employing an anti-virus resource data-center.

As seen in FIG. 1A, at step 1 a group of web sites or web-based resources, are selected for inclusion in a data-center and/or as web-based resources to be scanned for viruses. Step 1 may be carried out continuously at the data center, for example to group the most popularly “requested to be scanned” resources.

The group of web-based resources to be included in the data-center server or to be scanned for viruses is typically selected according to popularity, such that popular web-based resources are included in the data-center.

It is appreciated that at updating stages, the data-center server may identify a sub-group of web-based resources included therein that are known to be static resources, in which the data does not change over a configurable, predefined period of time, and therefore these web-based resources would be scanned for virus updates less frequently than other, more dynamic, web based resources. Such static resources would typically include pictures, multimedia files and PDF files. The data-center typically decides that a resource is static following receipt of input regarding this resource from multiple clients over a period of time, as described hereinbelow with reference to steps 11A and 11B.

As seen in step 2, for each such selected web-based resource, which is identified by a web-based resource URI, anti-virus checks are run on the resource at the data-center server or alternatively, at client machines which report the results of the anti-virus checks back to the data center, and the resource is classified as containing malware, or as not containing malware. The results of this classification are saved in a database in the data-center.

Subsequently or concurrently, a hash function, for example an MD-5 hash function is carried out on the web-based resource, and the result of the function is stored in the data-center server, as seen in step 3. The hash function is typically a one-to-one function identifying the resource as a unique string of characters. Additionally, as seen in step 4, a URI hash function is carried out on the URI, thereby enabling the data-center server to save the URI in a normalized and compact version, which is easily searchable.

The result of the hash function carried out on the web-based resource is used to verify that the resource requested at a client is identical to the resource for which the data center contains information. As explained in further detail hereinbelow, the client is instructed by the data-center to carry out the hash function for a resource, based on statistical methods which identify whether the resource is static and isn't changing over time, at different locations, or in any other way.

Preferably, the data-center server may prioritize the group of resources to be rescanned for viruses based on their age. Typically, the longer the resource has been known and has not changed, it is considered a “safer” resource and does not have to be rescanned for viruses quite as frequently as newer resources for which less information is available. The information stored in the data-center server regarding the resource also includes a time stamp indicating the time that this resource was last scanned.

In step 5, portions of the classification of the web-based resource, together with their respective MD-5 function value representing the resource and the hash function value representing the URI, is distributed to data-center clients, and is typically cached by the clients. Optionally, different clients may hold different parts of the data, such that different clients hold data pertaining to different URIs.

It is appreciated that the data-center server may distribute to clients incremental updates of the status of the various resources scanned by the server. Typically, incremental updates provided by the data-center include all the changes related to a group of related objects or resources, such as a group of information belonging to the same domain or subfolder within a domain. These changes may include changes to hash function values for objects in the group, and deletion or addition of objects or resources in the group.

Additionally, if the information regarding a specific resource includes a time stamp indicating when this resource was last scanned, the time stamp is also provided to the client. In this case, the client typically is instructed by the data-center server how to manage the cache.

As seen in step 6, when a client receives a request to perform an anti-virus scan on a given URI identifying a web-based resource, the client checks to see whether information relating to this resource may be included in the data-center, for example based on its belonging to a specific web site or domain.

If the data-center does not include information relating to the resource identified by the given URI, the client locally performs an anti-virus scan on the resource, as seen in step 7.

If the data-center may include information relating to the resource identified by the given URI, the client applies the URI hash function to the given URI, as seen in step 8. Alternately, the client may query the data-center for information relating to the given URI. Typically, when a client queries the data-center for information relating to a given URI, the data center will provide information relating to a group of objects or resources, such as all the objects or resources in a domain or a subfolder of a domain, which group includes the object identified by the given URI.

Turning to FIG. 1B, the client checks whether a URI hash function result identical to that calculated by the client for the given URI was obtained from or provided by the data center.

In step 9A, if the URI is one for which the data-center has not provided information to the client, or if the URI hash function as calculated by the client is not identical to the URI hash function result obtained from the data-center for the given URI, and therefore the client has no information from the data-related to the given URI, the client classifies the resource identified by the given URI as containing malware or as not containing malware, by locally running anti-virus checks on the content of the resource. The client additionally applies the MD-5 hash function to the resource and the URI hash function to the URI, and stores the results of these hash functions. As seen in step 9B, the client then forwards the full URI of the resource, together with the results of the URI hash function, MD-5 hash function and classification of the resource to the data-center server, where they are stored. Typically, the client would forward only information relating to URIs which the data center is likely to store information about, such as information related to URIs belonging to popular web sites. Alternatively, the client may forward information to the data center regarding any URI, and the data-center would only store information related to interesting or popular web sites.

Otherwise, if the URI is one for which the data-center has provided information to the client, as seen in step 10, the client typically proceeds to carry out the MD-5 hash function on the resource. However, for some URIs, which are known by the data-center to identify static resources, this step is not carried out. In this case, when providing information for this resource, the data center provides information that the resource identified by the URI is static, and the malware classification results for it may be relied on even without comparing the MD-5 has function results.

Alternatively, for some resources, the data-center may provide instructions to the client to carry out a local anti-virus scan on a resource even though the resource has not changed or is not expected to have changed, typically in order to verify that the client anti-virus scan obtains the same results as those obtained by the data-center. In this case, it would not be necessary for the client to calculate the MD-5 hash function and compare the results to those obtained by the data-center.

The client then compares the result to the MD-5 hash function result provided by the data-center for that URI. Typically, an MD-5 hash function match would occur if the resource identified by the URI is static, and does not change, and an MD-5 hash function mismatch would occur if the resource identified by the URI is dynamic, such that the resource which was applied to the MD-5 hash function in the data-center server is not identical to the resource received by the client.

If the result of the MD-5 hash function calculated by the client matches the result of the MD-5 hash function provided by the data-center, the client concludes that the content of the resource identified by the URI is static, that is, the content of the resource has not changed for a predetermined time period, and notifies the data-center server of this, as seen in step 11A. Since the content of the resource is static, the client can rely the anti-virus classification of the resource as provided by the data-center without having to scan the resource again to check whether it contains malware, as seen in step 11B.

It is appreciated that even static content may need occasional scanning, as new types of viruses are identified and thus a resource that has been declared malware free at a certain point in time may at a later stage, when new virus definitions are released and the resource is rescanned, be declared as including malware. Typically, the data-center rescans even static content resources every predetermined period of time, or instructs the client to do so.

Otherwise, if the result of the MD-5 hash function calculated by the client does not match the result of the MD-5 hash function provided by the data-center, the client concludes that the content of the resource identified by the URI is dynamic, as seen in step 12A, and notifies the data-center server of this. Since the content of the resource is dynamic, the client cannot rely on the anti-virus classification of the resource as provided by the data-center server, and therefore the client locally performs an anti-virus scan on the resource, as seen in step 12B. As seen in step 12C, the client then provides to the data-center the given URI together with the result of the MD-5 hash function as obtained by the client. Preferably, and typically for popular resources, the client also provides the results of the local anti-virus scan to the data-center.

It is appreciated that the MD-5 function of a resource identified by a given URI as calculated by a client may mismatch the MD-5 function of the same URI as calculated by the data-center server, if the URI is directing an attack at specific clients, and thus the content of the resource as shown to the specific clients would include malware whereas the content of the resource as shown to clients not being targeted would not include malware.

It is appreciated that though the methodology of the present invention has been described with reference to anti-virus scanning, it may be applied to any other type of scanning of files, for example malware scanning.

It is further appreciated that steps 2-4 need not necessarily be carried out by the data-center server, and may alternatively be carried out in a peer-to-peer system, in which most of the scanning is performed at the clients, and the scanning results are shared with the data-center which then stores and distributes them to other clients.

It will be appreciated by persons skilled in the art that the present invention is not limited to what has been particularly shown and described hereinabove. Rather the scope of the present invention includes both combinations and subcombinations of the various features described hereinabove as well as modifications and variations thereof as would occur to a person of skill in the art upon reading the foregoing specification and which are not in the prior art.

1. A method for reducing object scanning load in a network, the method comprising:
employing a data-center to provide to a client identifying information and classification information relating to a plurality of objects;
at said client, obtaining identifying information for a given object;
at said client, comparing said identifying information for said given object to said identifying information relating to said plurality of objects; and
if identifying information relating to one of said plurality of objects is the same as said identifying information for said given object, relying on said classification information relating to said one of said plurality of objects as provided by said data center.

2. A method according to claim 1 and also comprising, prior to said employing a data-center to provide, employing said data center to select said plurality of objects.

3. A method according to claim 2 and wherein said employing said data-center to select comprises employing said data-center to select popular objects as said plurality of objects.

4. A method according to claim 2 and wherein said employing said data-center to select comprises employing said data-center to select objects for which classification information was last obtained a predetermined time duration earlier as said plurality of objects.

5. A method according to claim 1 and also comprising, prior to said employing a data-center to provide, obtaining said identifying information and said classification information for each of said plurality of objects.

6. A method according to claim 5 and wherein said obtaining is carried out at said data-center.

7. A method according to claim 5 and wherein said obtaining is carried out by a plurality of clients, and said plurality of clients provide said identifying information and said classification information to said data-center.

8. A method according to claim 1 and wherein said object comprises a web based resource, and said object identifying information comprises a URI.

9. A method according to claim 1 and wherein said object comprises a web based resource and said object identifying information comprises at least one of a result of a function carried out on a URI of said web based resource and a result of a function carried out on said web based resource.

10. A method according to claim 1 and wherein said classification information comprises an anti-virus classification of said object.

11. A method according to claim 1 and also comprising, following said comparing:
if identifying information for said given object is not the same as identifying information relating to any of said plurality of objects, calculating said classification information for said given object at client; and
providing said identifying information for said given object as obtained at client to said data-center.

12. A method according to claim 11 and also comprising, following said providing said identifying information, providing said classification information for said given object as calculated at client to said data-center.
